(19) United States
(12) Patent Application Publication
(10) Pub. No.: US 2008/0140960 A1
(43) Pub. Date: Jun. 12, 2008

(54) SYSTEM AND METHOD FOR OPTIMIZING MEMORY USAGE DURING DATA BACKUP

(76) Inventors: Jason Ferris Basler, Los Gatos, CA (US); Avishai Haim Hochberg, San jose, CA (US); Charles Alan Nichols, Tucson, AZ (US); Vadzim Ivanovich Piletski, San Jose, CA (US); Thomas Franklin Ramke, Vonore, TN (US); James Patrick Smith, Redwood City, CA (US); Peter Tanenhaus, Vestal, NY (US)

Correspondence Address: Kunzler & McKenzie, 8 EAST BROADWAY, SUITE 600, SALT LAKE CITY, UT, 84111, US

(21) Appl. No.: 11/567,627

(22) Filed: Dec. 6, 2006

(51) Int. Cl. G06F 13/28; G06F 12/00

(52) U.S. Cl. 711/162; 711/4; 711/E12.028; 711/E12.002

(57) ABSTRACT

A system and method to optimize memory usage during data backup. The system generates lists of files and attributes corresponding to local files and backup files, selectively allocates storage of the lists to the hard disk and/or memory, compares the lists, and updates the backup files to reflect differences between the local files and the backup files. At least a portion of the lists may be allocated to hard disk storage based on preestablised criteria such as historical memory usage, a dynamic determination of the amount of available memory relative to the amount of memory needed to perform a current backup, or a prior determination of the amount of available memory compared to the amount of memory required to perform a current backup. In this manner, the present invention efficiently utilizes memory resources to perform incremental backup procedures quickly and reliably and facilitates large scale file backup.

### BACKGROUND OF THE INVENTION

1. Field of the Invention

The invention relates to systems and methods for backing up data. Specifically, the invention relates to systems and methods to optimize memory usage during data backup to enable large scale incremental backup within an allotted period of time.

2. Description of the Related Art

Recent advances in disk storage have made it possible to store increasingly large numbers of files on a computer at minimal expense. As a result, simplistic data management systems, while adequate to manage and protect smaller quantities of data, may fall short where large scale data management is required.

Traditionally, for example, a file attribute bit, or archive bit, has been used to indicate whether a local file has undergone a data change since a previous data management operation. The archive bit, however, is vulnerable to corruption by other user processes, thereby compromising its reliability. Moreover, the archive bit fails to take into account server conditions that may require a local file to be backed up, such as damage to or deletion of a backup file.

In response to these shortcomings, modern data management systems have implemented incremental backup systems utilizing complex file attribute information to identify and differentiate between various types of data changes on the local system, as well as on the server. Incremental backup methods effectively reduce an amount of data sent to the server for backup and therefore save both network bandwidth and server storage space.

Tivoli Storage Manager® data management system, for example, protects an organization's data by storing file attribute information in a central repository. File attribute information may include, for example, update and creation time, date, size, access control lists (‘ACL”) and extended information such as mode information, sizes and checksums of relative data streams, and the like. A storage management client application scans the local file system to generate a list of file names and their associated attributes, and then compares the list with the list stored in the central repository. This comparison identifies: (1) new files present on the local file system that are not present in the central repository; (2) deleted files present in the central repository that are not present on the local file system; and (3) changed files having a different set of attributes in the local file system than in the central repository.

While this information effectively streamlines data management operations, it can also require huge amounts of memory and time. Typically, in fact, many gigabytes of memory are needed to represent files in a local or central repository file list. For large scale data backup, the amount of memory needed to accomplish a comparison of file lists may easily exceed the amount of real or virtual memory available for such an operation. Moreover, the amount of time required to scan for files stored locally and in the central repository to create file lists for comparison can exceed available time.

Other prior art data management systems have attempted solutions to these problems by, for example, breaking up logical file systems into smaller logical file systems, extending the amount of virtual memory available, processing entries from a server one directory at a time, and/or journaling changes to data on the local system. Each of these solutions, however, suffers from individual shortcomings. Particularly, breaking up logical file systems into multiple logical file systems may be unattractive to customers that inherit large file systems due to server or information technology consolidation processes. Extending an amount of virtual memory available only postpones the problem of insufficient memory. Processing entries from a server one directory at a time may nevertheless deplete memory and time resources where many files are stored within a single directory. Journaling systems are not compatible with all operating systems and/or file systems, and may be unreliable, requiring reconciliation with a central repository to ensure their accuracy. Such reconciliation processes may also require excessive memory and time resources.

From the foregoing discussion, it should be apparent that a need exists for a system and method to optimize memory usage during data backup. Beneficially, such a system and method would facilitate reliable data backup on a large scale basis while promoting efficient data management and efficient use of memory and time resources. Such a system and method are disclosed and claimed herein.

### SUMMARY OF THE INVENTION

The present invention has been developed in response to the present state of the art, and in particular, in response to the problems and needs in the art that have not yet been met for optimizing memory usage during data backup. Accordingly, the present invention has been developed to provide a system and method for optimizing memory usage during data backup that overcomes many or all of the above-discussed shortcomings in the art.

A system according to the present invention may include a computer and a server, a generation module, an allocation module, a comparator module, and an update module. The computer may include memory and a hard disk, and may store local files on the hard disk. The server may store backup files corresponding to a prior version of the local files.

The generation module may generate lists of files and attributes. Particularly, the generation module may generate from the computer a first list of local files and associated attributes, and may generate from the server a second list of backup files and associated attributes. In some embodiments, the generation module may select a time other than within a designated backup window to generate the first list. The allocation module may allocate storage of the first and second lists to the hard disk, memory, or both according to preestablished criteria. Memory may include either or both of real memory and virtual memory.

Preestablished criteria may include, for example, the amount of memory required to perform prior backups, a dynamic determination of the amount of available memory compared to the amount of memory required to perform a current backup, or a prior determination of the amount of available memory compared to the amount of z memory required to perform a current backup.

In any case, the comparator module may compare the first list to the second list to identify differences between the local files and the backup files. The update module may then update the backup files to reflect the differences. In some embodiments, the update module may further transmit the updated backup files to the server for storage.

A method of the present invention is also presented for optimizing memory usage during data backup. In one embodiment, the method includes accessing local files stored on a hard disk of a computer and accessing backup files stored on a server. The backup files may correspond to a prior version of the local files. The method further includes generating from the computer a first list of the local files and associated attributes, and generating from the server a second list of the backup files and associated attributes. The first list may be generated at a time other than within a designated backup window.

The next step of the method comprises allocating storage of each of the first and second lists to the hard disk, memory, or both according to preestablished criteria. The method further includes comparing the first list to the second list to identify differences between the local files and the backup files, and updating the backup files to reflect the differences.

As in the system, memory may include real memory, virtual memory, or both. Likewise, preestablished criteria may include the amount of memory required to perform prior backups, a dynamic determination of the amount of available memory compared to the amount of memory required to perform a current backup, and/or a prior determination of the amount of available memory compared to the amount of memory required to perform a current backup.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating backup system structures utilized in connection with embodiments of the present invention;

FIG. 2 is a block diagram illustrating modules for backing up data in accordance with the present invention; and

FIG. 3 is a flow chart of a process for backing up data in accordance with certain embodiments of the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

As used in this specification, the term “backup” or “data backup operation” refers to a process of copying data from a primary storage location to a secondary storage location to enable restoration of the data in case of disaster, corruption, deletion, or other data loss event.

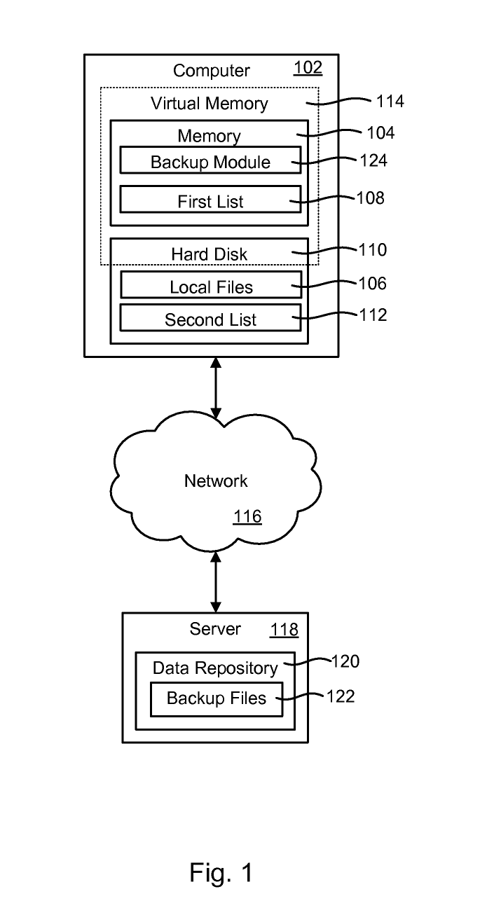

Referring now to FIG. 1, a system 100 to optimize memory usage during data backup in accordance with the present invention may comprise a computing device 102 communicating with a server 118 over a network 116. The network 116 may comprise, for example, a local area network (“LAN”), a wide area network (“WAN”), the World Wide Web, or any other network known to those in the art. The computing device 102 may include a desktop computer, a laptop computer, a personal digital assistant (“PDA”), a cell phone, or any other computing device known to those in the art. The computing device 102 may include memory 104 and a hard disk 110.

Memory 104 may include physical memory 126 and/or virtual memory 114, where virtual memory 114 includes a portion of the hard disk 110 in addition to physical memory 126. Virtual memory 114 enables information to be transparently swapped between the hard disk 110 and physical memory 126, thereby effectively increasing memory capacity. This technique alone, however, may degrade system performance if used too heavily. Accordingly, embodiments of the present invention provide systems and methods to optimize memory resources during backup, thereby facilitating large scale data backup while avoiding an adverse impact on system performance.

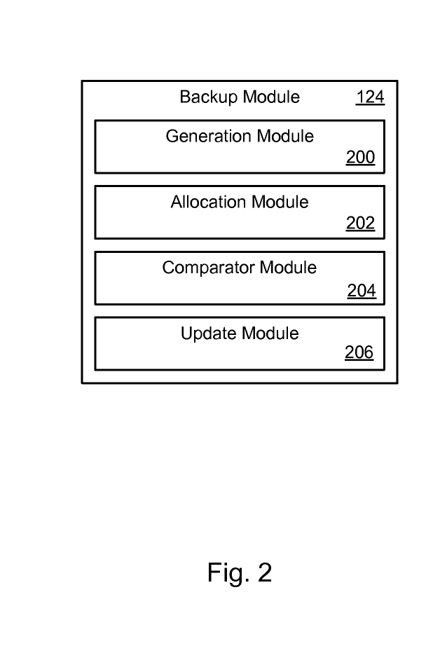

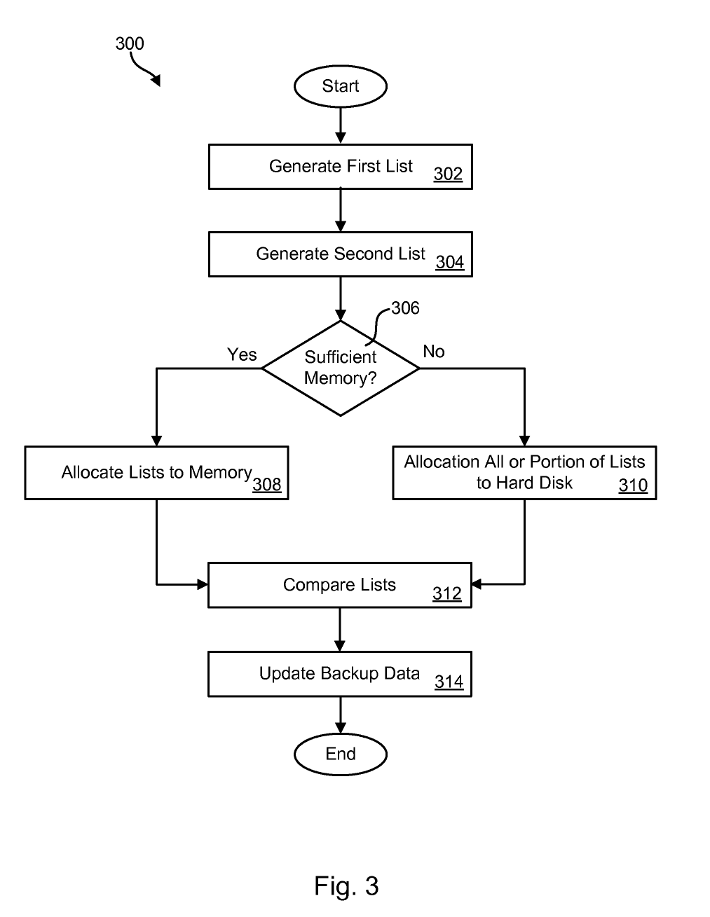

Specifically, in certain embodiments, the computing device 102 may store a backup module 124 in memory 104 to back up local files 106 stored on the hard disk 110. Backup files 122 corresponding to a previous version of the local files 106 may be stored in a data repository 120 on the server 118. The backup module 124 may optimize memory usage during a data backup operation in accordance with embodiments of the z present invention, as discussed in more detail with reference to FIGS. 2 and 3 below.

In brief, the backup module 124 may generate lists 108, 112 corresponding to each of the local files 106 and the backup files 122. Particularly, a first list 108 may correspond to the local files 106, and a second list 112 may correspond to the backup files 122. Each list 108, 112 may include the file names for each of the local files 106 and the backup files 122, as well as their associated attributes. Associated attributes may include, for example, update and creation time, date, size, access control lists (“ACL”), and/or extended attributes such as mode, information, sizes and checksums of relative data streams, and the like. Each list 108, 112, or portion thereof, may be stored in memory 104 or on the hard disk 110, according to preestablished criteria, as discussed in more detail below. The backup module 124 may compare the lists 108, 112 to determine differences between the local files 106 and the backup files 122, and then update the backup files 122 to reflect the differences.

Referring now to FIG. 2, the backup module 124 may specifically include a generation module 200, an allocation module 202, a comparator module 204, and an update module 206. The generation module 200 may scan the hard disk 110 of the computing device 102 to generate the first list 108 of local files 106 and associated attributes, and scan the data repository 120 of the server 118 to generate the second list 112 of backup files 122 and associated attributes. As previously discussed, the backup files 122 may correspond to a prior version of the local files 106.

In some embodiments, the generation module 200 may scan the data repository 120 of the server 118 to generate the first list 108 of local files 106 and associated attributes at a time other than that allotted for the data backup operation. The generation module 200 may then save the first list 108 to disk 110 for later access. By enabling at least a portion of the data backup operation to be completed outside of a designated backup window in this manner, the present invention may both facilitate completion of the data backup operation within the window of time allotted thereto, and reduce memory resources consumed.

The allocation module 202 may allocate storage of each of the first list 108 and the second list 112 to the hard disk 110, memory 104, or both according to preestablished criteria. For example, in some embodiments, the allocation module 202 may allocate storage of either list 108, 112, or portion thereof, to the hard disk 110 if historical evidence indicates that the amount of memory 104 required to perform prior backups of the local files 106 has exceeded available memory 104. In other embodiments, the allocation module 202 may allocate storage of either list 108, 112, or portion thereof, to the hard disk 110 according to a dynamic assessment indicating that the amount of available memory 104 is less than the amount of memory 104 required to perform a current backup. In this embodiment, storage may be allocated to the hard disk 110 when available memory 104 is deplete, or when available memory 104 or required memory 104 reaches a predefined threshold. In still other embodiments, the allocation module 202 may allocate storage of either list 108, 112, or portion thereof, to the hard disk 110 in response to a prior determination that the amount of available memory 104 is insufficient relative to the amount of memory 104 required to perform a current backup. In this manner, the allocation module 202 may make a measured determination of the status of memory resources available, thereby enabling optimal use of such resources during a data backup operation.

The comparator module 204 may compare the first list 108 to the second list 112 to identify differences between the local files 106 and the backup files 122. In some embodiments, the comparator module 204 may isolate one or more particular attributes associated with each file included in the list 108, 112 to provide a basis for comparison. In other embodiments, the comparator module 204 may prioritize attributes associated with each file to facilitate data management operations as well as data backup. The update module 206 may then update the backup files 122 to reflect the differences, and, in some embodiments, may transmit the updated backup files 122 to the server 118 for storage.

Referring now to FIG. 3, a method 300 for optimizing memory usage during data backup in accordance with the present invention may proceed as follows. The method 300 may include generating 302 a first list 108 corresponding to the local files 106. As previously discussed with reference to the system 100, this step may include scanning the hard disk 110 to generate the first list 108. In certain embodiments, such as those where the generating 302 step occurs at a time other than within a designated backup window, the first list 108 may be immediately saved to disk 110 for later access. Otherwise, storage of the list 108 may be allocated according to one of the allocating steps 308, 310 discussed below.

The method may further include generating 304 a second list 112 corresponding to the backup files 122. This step may include scanning the data repository 120 to generate the second list 112. Storage of the list 112 may be allocated according to either of the allocating steps 308, 310 discussed below.

The method 300 may proceed to determining 306 whether there is sufficient memory 104 available relative to the memory 104 required for the backup operation. The determining 306 step may be based on preestablished criteria, such as historical evidence of the amount of memory 104 required to perform prior backups, a dynamic determination of the amount of available memory 104 compared to the amount of memory 104 required to perform a current backup operation, or a prior determination of the amount of available memory 104 compared to the amount of memory 104 required to perform a current backup.

If the preestablished criteria indicates that there is sufficient memory 104 to perform the current backup operation, the method 300 may allocate 308 either or both of the lists 108, 112, or portion thereof, to memory 104. Otherwise, the method 300 may allocate 310 at least a portion of one or both lists 108, 112 to hard disk 110 storage.

Where at least a portion of the lists 108, 112 is allocated to hard disk 110 storage, the present invention may exploit disk caching capabilities of the computing device 102 to facilitate uncompromised system performance. Specifically, the present invention may access cached copies of information stored to the hard disk 110, thus facilitating quick and reliable data backup.

A next step of a method 300 in accordance with the present invention may include comparing 312 the lists 108, 112 generated by the generating steps 302, 304 to identify differences between the local files 106 and the backup files 122. This comparison may be based on attributes associated with each of the local files 106 and the backup files 122, such as update and creation time, date, size, access control lists (“ACL”), and/or extended attributes such as mode, information, sizes and checksums of relative data streams, and the like. Finally, the method 300 may include updating 314 the backup files 122 to reflect the differences. In some embodiments, updating 314 may include transmitting the updated backup files 122 to the server 118 for storage.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system to optimize memory usage during data backup, the system comprising:
a computer having memory and a hard disk, the computer storing local files on the hard disk;
a server storing backup files corresponding to a prior version of the local files;
a generation module to generate from the computer a first list of the local files and associated attributes and to generate from the server a second list of backup files and associated attributes;
an allocation module to allocate storage of each of the first and second lists to at least one of the hard disk and the memory according to preestablished criteria;
a comparator module to compare the first list to the second list to identify differences between the local files and the backup files; and
an update module to update the backup files to reflect the differences.

2. The system of claim 1, wherein the memory comprises at least one of real memory and virtual memory.

3. The system of claim 1, wherein the preestablished criteria is selected from the group consisting of the amount of memory required to perform prior backups, a dynamic determination of the amount of available memory compared to the amount of memory required to perform a current backup, and a prior determination of the amount of available memory compared to the amount of memory required to perform a current backup.

4. The system of claim 1, wherein the generation module selects a time other than within a designated backup window to generate the first list.

5. A method to optimize memory usage during data backup, the method comprising:
accessing local files stored on a hard disk of a computer;
accessing backup files on a server, the backup files corresponding to a prior backup of the local files;
generating from the computer a first list of the local files and associated attributes;
generating from the server a second list of the backup files and associated attributes;
allocating storage of each of the first and second lists to at least one of the hard disk and memory according to preestablished criteria;
comparing the first list to the second list to identify differences between the local files and the backup files; and
updating the backup files to reflect the differences.

6. The method of claim 5, wherein the memory comprises at least one of real memory and virtual memory.

7. The method of claim 5, wherein the preestablished criteria is selected from the group consisting of the amount of memory required to perform prior backups, a dynamic determination of the amount of available memory compared to the amount of memory required to perform a current backup, and a prior determination of the amount of available memory compared to the amount of memory required to perform a current backup.

8. The method of claim 5, wherein generating from the server the first list further comprises selecting a time other than within a designated backup window to generate the first list.
